(19) United States
(12) Patent Application Publication
(10) Pub. No.: US 2026/0064973 A1
(43) Pub. Date: Mar. 5, 2026

(54) USING COMMUNITY DETECTION TO AUTOMATICALLY PARTITION SEMANTICALLY SIMILAR LLMS CHAT SESSIONS

(71) Applicant: Dell Products L.P., Round Rock, TX (US)

(72) Inventors: Ítalo Gomes Santana, Rio de Janeiro (BR); Diego Vrague Noble, Pelotas (BR); Miguel Paredes Quiñones, Campinas (BR); Roberto Nery Stelling Neto, Rio de Janeiro (BR); Vicente J.P. Amorim, João Monlevade (BR)

(21) Appl. No.: 18/826,028

(22) Filed: Sep. 5, 2024

(51) Int. Cl. G06F 40/35; G06F 40/166

(52) U.S. Cl. CPC G06F 40/35; G06F 40/166

(57) ABSTRACT

One example method includes for each of one or more interactions of a chat session between a user and a chatbot, performing a building phase that comprises mapping the interaction into either a graph or an n-dimensional space, performing a verification phase that comprises partitioning the chat session, and using partitions of the chat session obtained during the verification phase to generate a subject-wise summarization of the chat session and/or to generate multiple chat sessions.

### TECHNOLOGICAL FIELD OF THE DISCLOSURE

Embodiments disclosed herein generally relate to LLM (large language model) chat sessions. More particularly, at least some embodiments relate to systems, hardware, software, computer-readable media, and methods, for partitioning semantically similar chat sessions.

### BACKGROUND

Current architectures of LLMs typically have two common drawbacks, namely, (1) each new query submitted by a user to the LLM is independent from previous queries, as LLMs do not store any past interactions, and (2) the query size is limited to a few thousand tokens. An interaction is a pair question/answer within a conversation between a user and the LLM. A common mechanism to address (1) is sometimes referred to as ‘memory,’ that is, the memory of the LLM. In that mechanism, each prompt will consider a formatted input that includes past interactions alongside with the new input prompt in a way to make the LLM aware about its previous replies to the user. By chaining previous and current prompts and even previous replies, the LLM generates more accurate responses at the cost of reducing the number of tokens available in the current query.

To address (2), a common approach is to summarize past interactions. Summarization is particularly challenging when multiple subjects are considered in a single conversation, or chat, at the same time. As an example, if a chain of interactions between a human and an LLM, which may be referred to as a ‘chatbot,’ is simultaneously related to cars, astronomy, pet foods, and financial advice, a specialized tool for summarization, such as another LLM instructed for summarization, will possibly generate low-quality summaries when multiple subjects are mixed, instead of yielding consistent summaries of each different subject. This type of chat session, with multiple topics, is sometimes referred to as an overloaded chat session.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings.

FIG. 1 discloses aspects of a building phase, according to one embodiment.

FIG. 2 discloses aspects of a verification phase, according to one embodiment.

FIG. 3 discloses an operation in which an incoming interaction I₁₀ is included into G and connects to {I₁, I₂, I₃, I₆}, according to one embodiment.

FIG. 4 discloses a CD algorithm applied on G and its transformation to three independent graphs (G₁, G₂, G₃), according to one embodiment.

FIG. 5 discloses aspects of a computing entity configured and operable to perform any of the disclosed methods, processes, and operations.

### DETAILED DESCRIPTION OF SOME EXAMPLE EMBODIMENTS

One or more embodiments disclosed herein generally relate to LLM (large language model) chat sessions. More particularly, at least some embodiments relate to systems, hardware, software, computer-readable media, and methods, for partitioning semantically similar chat sessions.

One example embodiment comprises a system and method for using a community detection process to automatically partition semantically similar LLM chat sessions, such as may be conducted in connection with a chatbot that comprises an LLM. One embodiment of such a method may be performed in whole, or in part, by an LLM, possibly on-the-fly as one or more chat sessions are taking place. One embodiment of such a method may comprise a building phase, followed by a verification phase. In general, an embodiment of the building phase may comprise mapping user input interactions into a node or data point representation. An embodiment of the verification phase may group user interactions according to their subjects after the building phase ends. As a result, these groupings, or partitions, may be used in various ways, such as for creation of subject-wise summarizations, and/or for splitting a chat session into multiple chat sessions.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of at an embodiment is that a chat session overload may be avoided. An embodiment may provide improved responses by an LLM based on, for example, automatic splitting of chat sessions and/or summarization of same-subject interactions. An embodiment may automatically detect, and act upon, material changes in a chat conversation topic. An embodiment may improve LLM responses by reducing a volume of recorded user interactions. Various other advantages of one or more embodiments will be apparent from this disclosure.

### A. Context for One Embodiment

The following is a discussion of aspects of an example context for one embodiment. This discussion is not intended to limit the scope of the claims or this disclosure, or the applicability of the embodiments, in any way.

### A.1 Community Detection Algorithms

An objective of Community Detection (CD), or node clustering, algorithms is to partition networks, or graphs, into sets of vertices according to similarity measures that rely on graph topologies. As a result, each set, or community, becomes densely connected, that is, their vertices have maximal similarity to each other, while different communities are less connected, that is, their vertices have minimal similarity to each other.

To identify communities, these algorithms identify the hierarchical organization of the nodes and connections, allowing for grouping vertices based on their structural position in the network. According to the communities found by the algorithm, nodes that share many edges with other groups may have an important function of control and stability within the group, while nodes at the boundary of a community may work as mediators and leaders for exchanges between different communities. Reference is made here to “S. Fortunato, ‘Community detection in graphs,’ Physics Reports, no. 3-5, pp. 75-174, 2010,” which is incorporated herein in its entirety by this reference.

Algorithms for detecting communities are diverse and their application is heavily domain dependent. Traditional approaches are usually scalable to large graphs to provide high-quality partitions at the price of requiring an optimal number of partitions and limited to simple graphs. Recently, the use of deep learning strategies in this domain has posed as a promising alternative due to their capabilities in learning from data and generalization.

### A.2 Large Language Models

An LLM is a type of artificial intelligence model trained on a large corpus of text data that enables generative text tasks to be performed by the LLM. Models of this kind are useful for producing articles, summarization, translation, question and answering, paraphrasing, among many others, underpinning (and sometimes replacing) human-written texts. For the sake of brevity, reference is made here to “J. W. R. C. D. L. D. A. Alec Radford, ‘Language Models are Unsupervised Multitask Learners,’ https://cdn.openai.com/better-language-models/language_models_are_unsupervised_multitask_learners.pdf, 2019,” which is incorporated herein in its entirety by this reference.

### A.3 Chat Summarization Using LLMs

Summarization using LLMs can be either abstractive or extractive. In abstractive summarization, an LLM may use its generative power to create an output text that contains the main facts about the original text by semantically reorganizing the text in few words. On the other hand, extractive summarization only gets the main subjects and verbs that are more important for the text and systematically organize them.

One special case of text summarization is a chat transcription from interactions between a human and an LLM assistant, sometimes referred to as a chatbot. In this scenario, chat summarization is used to give context about previous conversations to the LLM assistant through the input prompt, that is, this approach is an example of a one-shot learning process. There are different strategies for summarizing chats to input prompts and the effective usage of them depends on how minimal the resulting output of a conversation should be considering its final quality. Using input prompt summary is a common practice among LLMs since these models do not have memory capabilities over past interactions and are based on transformers, which is efficient strategy to encode information as tokens but have a limited number for their processing.

### B. Overview of Aspects of One Embodiment

### B.1 Introduction

To overcome issues such as those noted herein, various embodiments are disclosed. In a first (1) embodiment, a chain of user-LLM interactions may be mapped into a graph followed by the partition of that graph into subgraphs for every subject. This approach may leverage the construction of a graph where each interaction is a graph node while a graph edge exists between a pair of interactions if and only if these interactions are sufficiently similar. This allows that the resulting graph is not complete, that is, not every node connects to all nodes, making Community Detection (CD) algorithms convenient to partition. In another embodiment (2), the vector embedding of each user-LLM interaction is considered, which enables algorithms, such as K-means clustering, to partition the data points, that is, the vector embeddings, into groups of similar subjects.

Thus, one example embodiment comprises an approach that enables not only driving the partition of overloaded conversations into meaningful separated partitions but also the generation of effective summarizations of “same-subject” interactions. The application of an embodiment in overloaded chats may be especially useful whenever the limit in the number of tokens of LLMs is reached, such that such an approach may be instrumental in guiding the partition of a single chat into multiple chats, one for each subject.

### B.2 Discussion

One example embodiment comprises a framework that detects and partitions different subjects present in a chain of user-LLM interactions, where each interaction is a pair composed of a user question, and the corresponding LLM response. Each partition, therefore, can be used to generate a refined summary of its corresponding subject, thus, making the whole content more meaningful to serve as context in following prompts to the LLM. Ultimately, the proposed subject-based partitioning can also drive the subdivision of the current chat session into multiple ones, which is especially imperative when the current chat session yields low-quality responses due to a long chain of interactions with a multitude of different subjects.

The modelling approach for a framework according to one embodiment may be general once it allows interactions to be represented as data points, or nodes, which may be grouped by any clustering algorithm. Such a framework may be more efficient than a simple data and node clustering approach as it leverages previous computations to accelerate interaction and partition assignments.

One embodiment comprises a method that includes a building phase and a verification phase. In this order, both phases may be repeatedly executed in an online regime. That is, whenever a new interaction, that is, a pair comprising a user input and the respective LLM output or response, is performed, both the building phase and the verification phase consider previous assignments for each partition and use them to effectively assign the new interaction to an existing partition or create a new partition.

As one embodiment of framework specializes in working on node and data point clustering, these two approaches are considered in turn below.

### B.2.1 Node Representation

Node clustering is especially useful in applications where determining the similarity among interactions precedes the clustering process. This may be important once the resulting graph will become sparse, making node clustering algorithms, such those from the family of CD, convenient to detect partitions of nodes according to their intra-community density.

For the sake of formality, let G=(V, E) be an undirected graph such that V and E stand for the set of nodes and vertices of G, respectively. In one embodiment, each node corresponds to an interaction, which is a prompt given by the user and its response given by the LLM. An edge between two nodes exists if both interactions are related to each other by a defined similarity criterion.

In an embodiment of a building phase, there are various mechanisms that can be employed. These include, but are not limited to, the following three examples.
a. For each incoming interaction i, a vector embedding vᵢ is created to represent a given interaction. Next, each distance between vᵢ and vⱼ, such that j∈V and vⱼ is a vector embedding for j, is calculated. A predefined threshold t is then used to denote S⊆V, which is a subset of vertices whose distances in relation to vᵢ are less than t (a parameter representing the minimum threshold for similarity). Once S is defined, insert the respective node in G to represent i and edges (i, j) for each j∈S. The set S can be interpreted as the semantic interaction neighborhood with regards to interaction i. Attention is given that the lowest the distance threshold t, the closer the interactions in the neighbors will be together with the decrease of |S|.
b. Based on a., an embodiment may reduce the total number of comparisons done by vᵢ to a fixed number |P|<<|V|, where |P| is the number of partitions. This reduction can be accomplished from the second interaction onwards by using the partitions found in the previous verification phase execution. In practice, the comparisons consider measuring the distance between vᵢ and vⱼ, such that vⱼ is the vector embedding of the summary of all interactions assigned to j∈P.
c. Construct a complete graph, by default in one embodiment, all nodes are connected to each other, and remove, for example, 90% of less similar interactions—that is, edges with lower weight than the threshold are pruned assuming that the weight is directly related to how similar two interactions are. In an embodiment, this graph building phase can be triggered every time a new interaction is completed or after n interactions, for example. This approach would require a weighted undirected graph which requires small additions to control this additional edge information.

After the building phase, the verification phase may trigger, possibly automatically, a community detection (CD) algorithm, which partitions G into sets of mutually similar vertices P, which represents a common conversational subject.

### B.2.2 Data Point Representation

Different from node clustering, data clustering is a way of determining partitions among all interactions. In this case, an embodiment may consider that, in the building phase, each incoming interaction i is subject to the calculation of its vector embedding vᵢ, which becomes a data point in an n-feature space. Once vᵢ is determined, in the verification phase, the partitions P can be determined according to the clusters found by any unsupervised learning algorithm such as, for example, K-means or DBscan. Additional capabilities of an embodiment of this phase are outlined below.

In node or data clustering approaches, the verification phase may employ additional procedures to make the overall performance of the proposed framework better. For example, employing online clustering algorithms, such as online K-means or any online CD algorithm for example, can result in significant performance improvements due to the real-time nature of the problem addressed in this ID. These algorithms belong to a special setting where data arrives over time and decisions must be made on-the-fly, thus, resulting in robust solutions, or partitions. Another improvement strategy may split the current chat session whenever the total number of tokens of all interactions violates the limit in the number of tokens of the LLM, or the token limit allocated for the summarization. In this scenario, the current chat session is split into multiple chat sessions, each one for each partition. Moreover, an embodiment may consider the fusion of two nodes, or data points, considering their respective distances. In this case, once the distance of the embeddings of those two nodes is sufficiently close to zero, both nodes, or data points, may be merged. In the same fashion, this merging process may also be employed to merge partitions by using the embeddings of their summaries. Indeed, this merging process may result in the loss of original information, which may be considered, especially in high-stake domains. By generating summaries based on partitions, one embodiment may retain smaller but representative contexts of each partition with regard to the whole pool of interactions.

Grouping user-LLM interactions into semantically similar subject partitions not only promotes better summarizations and potential token savings but also enables applications beyond these two objectives. For example, an embodiment may implement a multi-session subject aggregation in a user-LLMs long term interaction, in a way similar to the way in which email clients reorder and reorganize emails by thread instead of by date, where an interactive system may have an option to regroup conversations by their subject, instead of by chronological order. Another application, such as for providers of LLMs, may be the aggregation of interactions of all users in the system to identify globally common subjects, patterns, and even subject drifts, assuming that the nodes are time tagged. With one embodiment, it may be possible to use this approach to identify potential LLM exploits or use the community/cluster information to guide predictive conversational systems.

### B.3 Further Discussion

As will be apparent from this disclosure, an embodiment may comprise various useful features and aspects, although no embodiment is required to possess any of such features or aspects. The following examples are illustrative, but no exhaustive.

An embodiment may comprise a two-phase process that automatically splits conversations into multiple conversation sessions, potentially to promote better summarizations in addition to token usage savings. As another example, an embodiment may employ CD algorithms to detect significant changes on the current conversation topic. This departure from the traditional approach of clustering may add a new semantic layer of information by leveraging the relationship among nodes in the form of edges based on subject similarity. As a final example, an embodiment may comprise a method that reduces the data volume of recorded interactions to accelerate performance when managing a large pool of interactions. This may be accomplished by merging very similar interactions, or partitions, according to their respective distances, making a single merged interaction, or partition, more meaningful than the two equivalent ones that were merged.

### C. Detailed Discussion of Aspects of an Example Embodiment

As discussed earlier herein, a notable limitation in LLMs is that they have a constrained number of tokens for their input prompts. In the case of conversational AI (Artificial Intelligence) systems, this implies limited “memory” capabilities when using previous inputs and outputs to refine future answers to user queries. One approach to emulate “memory” in LLMs comprises directly attaching past interactions as context in the prompt along with the query, which aims at making the LLM “aware” of all past interactions when generating an accurate answer for a given query.

Although this simple approach may be expected to provide acceptable results with small chat sessions, its application can become infeasible in scenarios where chat sessions progressively get longer over time, which is, in fact, unpredictable. Usually, dealing with this issue requires replacing the context formed of past interactions by a corresponding summary when the maximum number of tokens of the LLM is reached. Ideally, such a summary would be a semantically equivalent representation of the past interactions but using a smaller number of tokens. This approach, however, comes with a significant disadvantage in that there is no safe or reliable way of controlling how the summarization tool, such as an LLM tailored for summarization for example, will generate its outputs, making their subsequent use in prompts prone to decrease quality in LLM responses.

In light of these and other considerations, one embodiment comprises a framework configured and operable to enhance summary quality on a subject basis by effectively partitioning all interactions. In an embodiment, the partitioning the pool of interactions by subjects may enable creation of refined summaries once a single summary that covers all interactions and, by consequence, all chat subjects, can indistinguishably combine passages from interactions of different subjects, thus, generating summaries that may, or may not, deviate from the ground truth.

As noted earlier herein, LLMs are likely to succeed in providing accurate answers by adding “memory” in the form of attaching previous interactions or an equivalent summary to the prompt. A high-quality summary is more convenient in this scenario due to at least two reasons, namely, (1) it is a concise representation of the chain of interactions, which decreases the likelihood that the LLM will focus on irrelevant information, and (2) potentially saves token usage. In one embodiment, the generated summaries are not only used as context data to LLMs, but also to drive the separation of a current conversation into multiple ones whenever the conversation, or chat, becomes overloaded.

More formally, an embodiment may map any interaction into a representation that permits the application of clustering algorithms to group interactions that are semantically similar according to their subjects. The representation of each interaction may be performed using either a node-based approach or a data-based approach. By using either, an embodiment may operate to provide high-quality summaries and, when a current conversation is sufficiently long, to split the current chat conversation, or chat session, into multiple conversations based on the partitions for each subject. To this end, an embodiment may comprise two phases, namely, (1) building and (2) verification, each of which are discussed in detail below, and each of which are, in one embodiment, executed in this order whenever a new interaction is created.

### C.1 Building Phase

In an embodiment, a building phase comprises mapping input interactions into a node representation, or a data point representation, where each incoming interaction i=(q, a), which includes a query q defined by the user and its associated answer a given by the LLM, is mapped into a graph, or into an n-dimensional space, followed by its subsequent use in a verification phase as described elsewhere herein.

### C.1.1 Node Representation

Let i=(q, a) be an interaction pair that comprises a query q defined by the user and its associated answer a given by the LLM. For the sake of simplicity, it may be assumed that q is a self-contained question, meaning that its wording does not contain references to previous questions, such as a follow-up question for example. An embodiment may comprise a simple preprocessing task to be adopted by recovering the context of any follow-up question from the first question of its chain, and its subsequent incorporation into the follow-up question to make it a self-contained question.

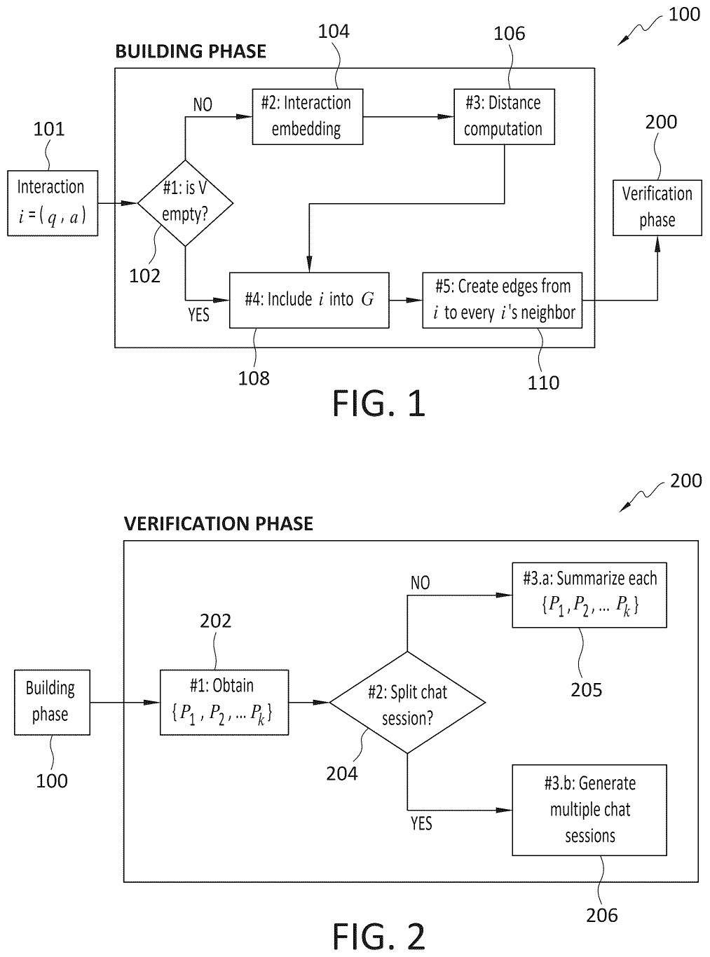

Next, an undirected graph G=(V, E) may be defined such that V is the set of interactions, that is, vertices, and E is the set of relations, that is, edges, between pairs of interactions. In brief, an algorithm according to one embodiment includes, at each iteration, adding a new node into G and creating edges between this new node and any existing nodes that are similar, where similarity may be determined, for example, according to a distance measure on the embeddings and a predefined distance threshold. With attention now to FIG. 1, there is disclosed an example method 100 for a building phase, according to one embodiment.

The operations of the example method 100 may be performed for each interaction 101 pair i=(q, a) of a group of one or more interactions 101. The example method 100 may begin with performing a check 102 (#1) to determine if V is empty, that is, whether |V| is equal to zero or not. If the check 102 indicates that V is empty, an empty set Sᵢ may be defined, and the method 100 may skip to 108 (#4). Otherwise, if the check 102 reveals that V is not empty, an interaction embedding process 104 (#2) may be performed. In an embodiment, the embedding process 104 may comprise computing a vector embedding vᵢ for i according to the LLM tokenizer. In one embodiment, vᵢ may represent the vector embedding of the concatenation of q and a into a single sentence.

Next, a distance computation 106 (#3) may be performed. In particular, the embedding calculated for i at 104 will have its distance compared with those of the existing nodes in V. While the distance computation between i and every j∈V represent, in one embodiment, a computational burden that is manageable for smaller |V|, it rapidly deteriorates the performance of the method 100 as |V| increases. Thus, a design decision for this example method 100 may consider v against the vector embedding of a respective summary of each partition, as described hereafter. In particular, it is noted that |V| may be at least 1, implying that a verification phase, an example of which is discussed below, was executed in a previous iteration, where a set of partitions P was determined with their respective summaries and their vector embeddings calculated. For example, consider SP the subset of partitions whose distances compared to i are below a distance threshold t_{SP} from i. These comparisons may be conducted using vᵢ against all vₚ for every p∈P such that vₚ is the embedding calculated on the summary of p. Next, for each partition sp∈SP, calculate the distances between vᵢ and vⱼ for every j∈sp, and define Sᵢ as the set of neighbor interactions in relation to i that are below a distance threshold tᵢ. Any distance computation may be used, and examples of such distance computation measures include, but are not limited to, cosine distance, dot product, and l2 squared.

The method 100 may then advance to 108 (#4) where i is included into G. In particular, a new node may be created in G to represent i. This can be simply done by labelling this node according to its insertion ordering in V. Additionally, query q and answer a can be stored into an additional data structure, such as a hash map, for example, which, in turn, uses the node label as key for its retrieval.

Finally, edges may be created 110 (#5) from i to every neighbor of i. In particular, for every j∈Sᵢ, create an edge (i, j)∈E in G. It is noted that the method 100 may be based on the concatenation of the query q and its answer a, as per 104 (#2), for every vᵢ, that is, embedding, computation. In using the pair (q,a), an embodiment may seek accuracy when computing embeddings and distances once more information about the same domain is available. This, however, can become a computational burden in some pipelines due to the concatenation of q and a.

To deal with this circumstance, an embodiment may use only q to compute vᵢ once q also expresses the intended context of the whole i=(q, a). This approach may provide for cost savings in at least two forms, namely, in (1) computing vᵢ, and (2) enabling the method 100 to execute without waiting for the LLM in producing a, allowing asynchronous pipelines that benefit I/O throughputs. However, employing this strategy may, in one embodiment, distort distance measures once q cannot be sufficiently representative to a context. Besides that, another improvement opportunity in this approach relies on defining Sᵢ with a much smaller number of comparisons. In particular, an embodiment may prune a number of interactions considering their subjects in a first evaluation by defining SP, then define Sᵢ considering only interactions that belong to the partitions of SP, as explained above.

With continued reference to FIG. 1, after the edges are created 110 (#5), the building phase, or at least this iteration of the building phase, may be complete. Next, and as discussed below, a verification phase 200 may be entered.

### C.1.2 Data Point Representation

While the node representation approach, as discussed above, comprises a specific way of mapping interactions into graphs for their subsequent grouping by community detection algorithms, the data point representation is straightforward in its mapping once no edges are considered. In particular, an embodiment may leverage the fact that a vector embedding vᵢ calculated using the LLM tokenizer for an interaction i=(q, a), for example, a concatenation of q and a as in 104 (#2) of the method 100, is an n-dimensional data point, where n is the number of features of vᵢ. This representation, therefore, may enable the use of traditional clustering algorithms, examples of which include, but are not limited to, K-means and DBScan, based on different strategies, such as hierarchical, distribution, and affinity, for example.

### C.2 Verification Phase

The following discussion of an example implementation of a verification phase subdivides the context partitioning phase explanation for node and data point representations, respectively. In an embodiment, an objective of the verification phase is to employ partitioning algorithms to group interactions according to their subjects after the building phase ends, that is, at each update on G, or in the n-dimensional space. As a result, in one embodiment, these partitions may be used in at least two different ways or for two different objectives, namely, (1) for subject-wise summarizations, and/or (2) for generating multiple chat sessions from a single chat session.

With respect to subject-wise summarizations (1), as each partition will retain same-subject interactions, a summary for each partition will circumvent the overloaded chat problem noted herein. This problem considers that different subjects at the same time, that is, in a single chat, are likely to generate low-quality summaries, which are unhelpful for yielding accurate responses when used as context in LLMs. On the other hand, in one embodiment, all interactions of the same partition may be summarized jointly, rendering the resulting summary a short representation of all historical data of that subject. For example, in such an embodiment, where a question q of a future interaction i=(q, a) can be quickly compared with each partition summary and, if any partition summary is close enough to q, that partition may be used as context for the LLM in generating a. In other words, the closest summary can be used as context within the LLM prompt towards producing an accurate a. As well, any incoming interaction can be directly compared with the existing summaries of each subject, and the closest ones compared against this interaction, possibly reducing drastically the number of possible comparisons in the building phase, as detailed earlier herein, such as in the discussion of FIG. 1.

With respect to generation of multiple chat sessions (2), an embodiment may operate to circumvent a limitation in the number of tokens that an LLM can deal with. This problem arises when the number of tokens of a given prompt to an LLM is greater than the token limit of the LLM, referred to as B (budget of tokens) herein. This prompt can be naively built using all interactions or considering their summaries as described in objective (1). Once this limit is reached, the prompt is simply truncated at this limit, and the remaining information discarded, when generating a response. In this way, an embodiment may create chat sessions for each subject by using the partitions.

In the following discussion, the objectives (1) and (2) are explored in more detail for each representation and a general algorithm for the verification phase is depicted as an example method 200 in FIG. 2. As shown, the method 200 may begin after completion of an iteration of the building phase 100.

In an embodiment, the method 200 begins with partitioning 202 (#1) all interactions into k subsets {P₁, P₂, . . . . Pₖ} followed by a decision 204 (#2) regarding whether or not the current chat session should be split. If not, the method 200 may proceed to 205 (#3.a) where each of the k partitions is summarized. It is noted that any algorithm or method may be employed on the pool of interactions, which includes algorithms that require k as an input hyperparameter and returns k partitions or, without any loss of generality, any algorithm that requires different hyperparameters, for example, a maximum number of nodes/interactions in each partition, or maximum number of tokens in each partition, and returns an unexpected number of partitions, which is k.

With continued reference now to the example method 200 in FIG. 2, the split decision 204 over the chat session is based on whether or not there is a violation of B. That is, if B is violated, the current chat session is split 206 (#3.b) into multiple chat sessions, one for each {P₁, P₂, . . . . Pₖ} (step #3.b), where this split may be resolved either automatically or manually. In the automatic way, one checks if the number of tokens of at least one partition is greater than B, then, the split is conducted, or manually leaving this decision to the user on a prompt window with proper explanations about response quality decrease in maintaining the current chat session. Otherwise, 205 (#3.a) may execute a summarization for each partition, which may be used in the building phase 100, as noted at 206 (#3.b.) discussed above.

Finally, it is noted that an embodiment may comprise two additional processing techniques to enhance the performance of the verification phase, exemplified at 200. Both techniques may be employed in one or more real-life use cases. The first of these processing techniques relies on the application of online clustering algorithms, such as online K-means or online community detection (CD), where these algorithms try to minimize the expected error in clustering incoming data into existing partitions without running its offline counterpart again. The second processing technique considers merging interactions, where two interactions that are sufficiently close to each other may be merged into a single interaction. To this end, an embodiment may implement a reduction of tokens by using a summary, so that once two close interactions are identified that are likely to contain duplicated information, those two interactions can be considered as a single interaction.

As in the case of the building phase of one embodiment, an embodiment of a verification phase may employ either node representation, or data point representation. These two approaches, in the context of a verification phase, are considered below.

### C.2.1 Node Representation

In the node representation approach, a verification phase, such as the verification phase 200 for example, starts with a single execution of a Community Detection (CD) algorithm on G to partition V into sets {P₁, P₂, . . . . Pₖ}. For 206 (#3.b) in the example of FIG. 2, a graph Gⱼ=(Vⱼ, Eⱼ) for each partition Pⱼ∈{P₁, P₂, . . . . Pₖ} is created by assigning all interactions of Pⱼ to Vⱼ, and, to define Eⱼ, all edges of E that mutually connect the vertices of Vⱼ. As each partition graph will contain semantically similar contexts. As a result, k chat sessions will be created, one for each new graph.

### C.2.2 Data Point Representation

In a verification phase that employs data point representation, the set of partitions {P₁, P₂, . . . . Pₖ} can be determined according to the clusters found by any unsupervised learning algorithm such as, for example, K-means or DBscan. The remainder of the algorithm is then executed such that at 206 (#3.b), each chat session will have its own n-dimensional space for all interactions assigned to it.

### C.2.3 Estimation of k

In one embodiment, a number for k may be estimated by including a “topic detection” tool to count each new topic entry at each time a query is given. One embodiment of this tool operates by estimating k “on-the-fly” by, at each interaction, that is, each pair [query, answer], that is, (q, a), executing a clustering algorithm, for the node and data point representation, and then calculating the distance between the interaction against all community centroids using their embeddings. Over these distances, an embodiment may use a threshold to detect whether the new interaction is sufficiently distant among all considered centroids to increase the counter. Another approach may use fine-tuned LLMs to detect context changes.

### D. Example Use Case for One Embodiment

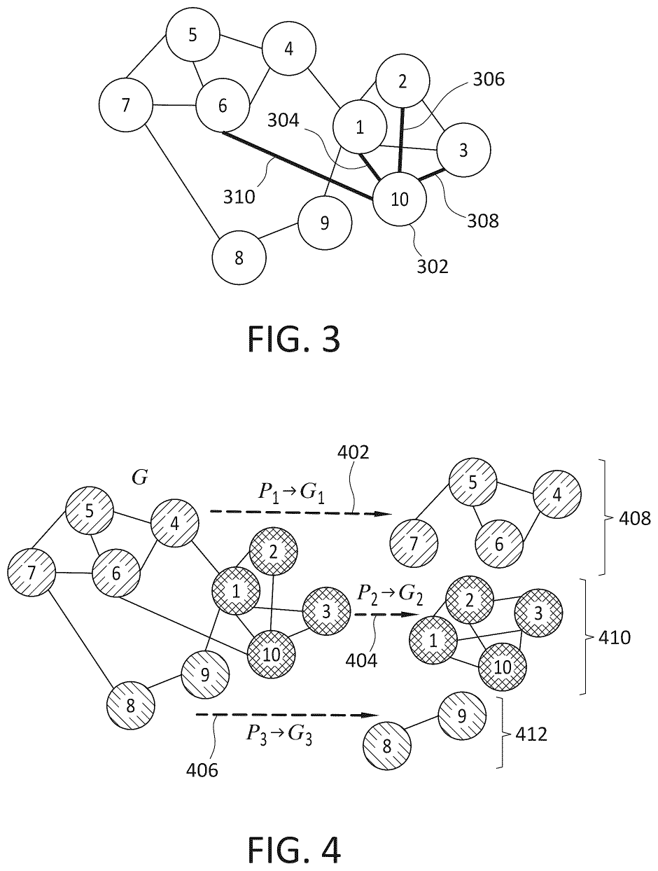

With reference now to the examples of FIG. 3 and FIG. 4, consider a chat conversation with an LLM assistant such that there exist nine interactions pairs. Let G be an undirected graph G=(V, E), where V is the set of conversations {I₁, . . . , I₉} and E={{I₁, I₂}, {I₁, I₃}, {I₁, I₄}, {I₁, I₉}, {I₄, I₅}, {I₄, I₆}, {I₅, I₆}, {I₅, I₇}, {I₆, I₇}, {I₇, I₈}, {I₈, I₉}}, and the sum of all tokens conversations is less than B.

Suppose that I₁₀=(q, a) is an incoming interaction pair that will be incorporated into G. To this end, an embodiment may execute the graph building, that is, building, algorithm or method disclosed herein. In those two first steps, the vector embedding 110 is determined, followed by calculating its distance against vᵢ for every i∈V. The set S₁₀ is then defined with all closest neighbors to I₁₀ in relation to a predefined threshold d. Assuming S₁₀={I₁, I₂, I₃, I₆}, a node for I₁₀ is created and incorporated into G as depicted in FIG. 3, which discloses, in particular, an incoming interaction I₁₀ 302 is included into G and connects to {I₁, I₂, I₃, I₆} as respectively indicated 304, 306, 308, and 310.

Further suppose that after I₁₀ is incorporated into V, as shown in the example of FIG. 3, the total number of tokens of all conversations becomes greater than B (budget of tokens). Thus, the trigger is activated, and the context partition procedure disclosed herein is started. By running a CD algorithm assuming k=3 using the procedure disclosed herein, three partitions {P₁, P₂, P₃} 402, 404, and 406, respectively, are determined as shown in FIG. 4. In more detail, FIG. 4 discloses an example CD algorithm applied on G and its transformation to three independent graphs (G₁, G₂, G₃) 408, 410, and 412, respectively. With respect to community detection, further information can be found in “S. X. F. L. J. W. J. Y. C. Z. W. H. C. P. S. N. D. J. Q. Z. S. P. S. Y. Xing Su, ‘A Comprehensive Survey on Community Detection With Deep Learning,’ IEEE Transactions on Neural Networks and Learning Systems, pp. 1-21, 2022,” incorporated herein in its entirety by this reference.

In this example, each partition Pⱼ is transformed into a respective individual graph Gⱼ, where Gⱼ can be translated as an individual chat conversation and the parameter d may be lowered. In practical terms, the original chat conversation is now split into three independent chat conversations. From now on, each of these new chat conversations is represented by its own graph and may be the subject of the procedures disclosed elsewhere herein. Note that, as far as the end user is concerned, his/her chat sequence may remain as it occurred as time progressed. The objective of one embodiment is primarily to split and group different chat snippets in the same community of subjects to improve the summarization task. But note that the splitting and community grouping procedure may also be used to present past conversations to the user, so that similar content conversations may be presented that are grouped by subject instead of a ‘plain vanilla’ time ordering.

### E. Example Methods

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

In some embodiments, any of the disclosed methods may be performed by, and/or at the direction of, an LLM, such as an LLM that comprises a chatbot. In some embodiments, any of the disclosed methods may be performed online, such as while a chatbot is online and available to answer user queries, and/or may be performed offline such as while an LLM or chatbot is in a training phase.

### F. Further Example Embodiments

Following are some further example embodiments. These are presented only by way of example and are not intended to limit the scope of this disclosure or the claims in any way.

Embodiment 1. A method, comprising: for each of one or more interactions of a chat session between a user and a chatbot, performing a building phase that comprises mapping the interaction into either a graph or an n-dimensional space; performing a verification phase that comprises partitioning the chat session; and using partitions of the chat session obtained during the verification phase to generate a subject-wise summarization of the chat session and/or to generate multiple chat sessions.

Embodiment 2. The method as recited in any preceding embodiment, wherein the mapping comprises mapping the interactions into respective node representations.

Embodiment 3. The method as recited in embodiment 2, wherein mapping the interactions into node representations comprises: computing a vector embedding for each of the interactions; comparing a respective distance of each of the vector embeddings with respective distances of existing nodes in a set of interactions, where each of the distances represents a respective similarity of one of the interactions with another of the interactions; based on the comparing, and for each of the interactions, creating a respective node in a graph to represent the interaction; and creating, in the graph, edges from each of the nodes to respective neighbors of the nodes.

Embodiment 4. The method as recited in embodiment 3, wherein when one of the distances between two of the interactions is below a threshold, the nodes representing the two interactions are merged into a single node.

Embodiment 5. The method as recited in any preceding embodiment, wherein when the interactions are mapped into a graph, the verification phase triggers use of a community detection algorithm that partitions the graph into mutually similar vertices which each correspond to a different respective subject of the chat session.

Embodiment 6. The method as recited in any preceding embodiment, wherein the mapping comprises using a clustering algorithm to map the interactions into respective data points of the n-dimensional space.

Embodiment 7. The method as recited in any preceding embodiment, wherein the subject-wise summarization comprises multiple summaries, each corresponding to a different respective subject of the chat session.

Embodiment 8. The method as recited in any preceding embodiment, wherein the building phase and the verification phase are performed for each interaction of the chat session.

Embodiment 9. The method as recited in any preceding embodiment, wherein each interaction comprises a respective query submitted by the user, and an answer to the query, and the answer is generated by an LLM (large language model) of the chatbot.

Embodiment 10. The method as recited in any preceding embodiment, wherein the building phase and the verification phase are performed while maintaining adherence to a token budget of an LLM (large language model) of the chatbot.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### G. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

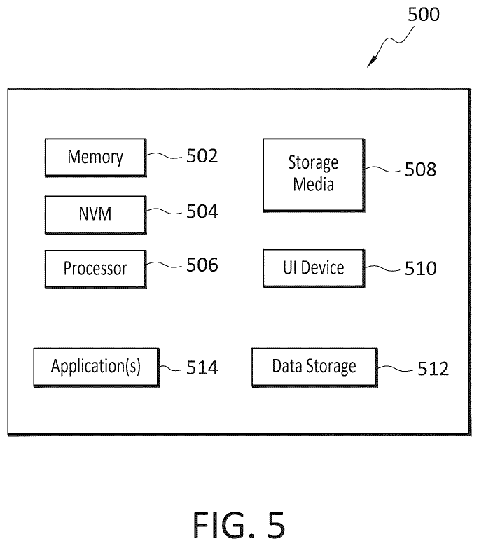

With reference briefly now to FIG. 5, any one or more of the entities disclosed, or implied, by FIGS. 1-4, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random-access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid-state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method, comprising:
for each of one or more interactions of a chat session between a user and a chatbot, performing a building phase that comprises mapping the interaction into either a graph or an n-dimensional space;
performing a verification phase that comprises partitioning the chat session; and
using partitions of the chat session obtained during the verification phase to generate a subject-wise summarization of the chat session and/or to generate multiple chat sessions.

2. The method as recited in claim 1, wherein the mapping comprises mapping the interactions into respective node representations.

3. The method as recited in claim 2, wherein mapping the interactions into node representations comprises: computing a vector embedding for each of the interactions; comparing a respective distance of each of the vector embeddings with respective distances of existing nodes in a set of interactions, where each of the distances represents a respective similarity of one of the interactions with another of the interactions; based on the comparing, and for each of the interactions, creating a respective node in a graph to represent the interaction; and creating, in the graph, edges from each of the nodes to respective neighbors of the nodes.

4. The method as recited in claim 3, wherein when one of the distances between two of the interactions is below a threshold, the nodes representing the two interactions are merged into a single node.

5. The method as recited in claim 1, wherein when the interactions are mapped into a graph, the verification phase triggers use of a community detection algorithm that partitions the graph into mutually similar vertices which each correspond to a different respective subject of the chat session.

6. The method as recited in claim 1, wherein the mapping comprises using a clustering algorithm to map the interactions into respective data points of the n-dimensional space.

7. The method as recited in claim 1, wherein the subject-wise summarization comprises multiple summaries, each corresponding to a different respective subject of the chat session.

8. The method as recited in claim 1, wherein the building phase and the verification phase are performed for each interaction of the chat session.

9. The method as recited in claim 1, wherein each interaction comprises a respective query submitted by the user, and an answer to the query, and the answer is generated by an LLM (large language model) of the chatbot.

10. The method as recited in claim 1, wherein the building phase and the verification phase are performed while maintaining adherence to a token budget of an LLM (large language model) of the chatbot.

11. A non-transitory storage medium having stored therein instructions that are executable by one or more hardware processors to perform operations comprising:
for each of one or more interactions of a chat session between a user and a chatbot, performing a building phase that comprises mapping the interaction into either a graph or an n-dimensional space;
performing a verification phase that comprises partitioning the chat session; and
using partitions of the chat session obtained during the verification phase to generate a subject-wise summarization of the chat session and/or to generate multiple chat sessions.

12. The non-transitory storage medium as recited in claim 11, wherein the mapping comprises mapping the interactions into respective node representations.

13. The non-transitory storage medium as recited in claim 12, wherein mapping the interactions into node representations comprises: computing a vector embedding for each of the interactions; comparing a respective distance of each of the vector embeddings with respective distances of existing nodes in a set of interactions, where each of the distances represents a respective similarity of one of the interactions with another of the interactions; based on the comparing, and for each of the interactions, creating a respective node in a graph to represent the interaction; and creating, in the graph, edges from each of the nodes to respective neighbors of the nodes.

14. The non-transitory storage medium as recited in claim 13, wherein when one of the distances between two of the interactions is below a threshold, the nodes representing the two interactions are merged into a single node.

15. The non-transitory storage medium as recited in claim 11, wherein when the interactions are mapped into a graph, the verification phase triggers use of a community detection algorithm that partitions the graph into mutually similar vertices which each correspond to a different respective subject of the chat session.

16. The non-transitory storage medium as recited in claim 11, wherein the mapping comprises using a clustering algorithm to map the interactions into respective data points of the n-dimensional space.

17. The non-transitory storage medium as recited in claim 11, wherein the subject-wise summarization comprises multiple summaries, each corresponding to a different respective subject of the chat session.

18. The non-transitory storage medium as recited in claim 11, wherein the building phase and the verification phase are performed for each interaction of the chat session.

19. The non-transitory storage medium as recited in claim 11, wherein each interaction comprises a respective query submitted by the user, and an answer to the query, and the answer is generated by an LLM (large language model) of the chatbot.

20. The non-transitory storage medium as recited in claim 11, wherein the building phase and the verification phase are performed while maintaining adherence to a token budget of an LLM (large language model) of the chatbot.
